(19) United States
(12) Patent Application Publication
(10) Pub. No.: US 2013/0293210 A1
(43) Pub. Date: Nov. 7, 2013

(54) COUPLED VOLTAGE CONVERTERS

(71) Applicants: Eric G. Smith, San Jose, CA (US); Louis Luh, Sunnyvale, CA (US); William C. Athas, San Jose, CA (US)

(72) Inventors: Eric G. Smith, San Jose, CA (US); Louis Luh, Sunnyvale, CA (US); William C. Athas, San Jose, CA (US)

(73) Assignee: APPLE INC., Cupertino, CA (US)

(21) Appl. No.: 13/472,068

(22) Filed: May 15, 2012

Related U.S. Application Data
(60) Provisional application No. 61/643,837, filed on May 7, 2012.

(51) Int. Cl. G05F 1/10

(52) U.S. Cl. 323/282

(57) ABSTRACT

Embodiments of a power supply are disclosed that include a first voltage converter having a first feedback controller and a first regulated output, and second voltage converter having a second feedback controller and a second regulated output electrically coupled to the first regulated output. The power limit of the first voltage converter is lower than the power limit of the second voltage converter, and a reference voltage for the first feedback controller is higher than the reference voltage for the second feedback controller.

### RELATED APPLICATION

This application hereby claims priority under 35 U.S.C. §119 to U.S. Provisional Application No. 61/643,837, entitled “Coupled Voltage Regulators,” by Eric Smith, and Louis Luh, filed 7 May 2012 (Atty. Docket No.: APL-P14735USP1), which is hereby incorporated by reference.

### BACKGROUND

1. Field

The present embodiments relate voltage converters. More specifically, the present embodiments relate to coupled voltage converters.

2. Related Art

Often, power supplies for electronic devices such as smartphones, tablet computers, laptop computers, and desktop computers are designed to efficiently supply a wide range of power levels for a time-varying load such as a central processing unit (CPU) or graphics processing unit (GPU). However, power supplies designed to work equally well over such a wide range of power demands are typically not as efficient as power supplies optimized to supply power over a narrow range of loads. Additionally, although the control logic for a power supply that can deliver power over a wide range of power demands may be stable at a constant power level, transitioning between output power levels may cause increased inaccuracy in the regulated output voltage.

Hence, the use of power supplies may be facilitated by improvements related to their design.

### BRIEF DESCRIPTION OF THE FIGURES

FIG. 1 shows a power supply in accordance with an embodiment.

FIG. 2 depicts exemplary graphs of the output voltage, load current and PWM signals of buck supplies in accordance with an embodiment.

FIG. 3 shows a power supply including three voltage converters in accordance with an embodiment.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

The methods and processes described herein can be included in hardware modules or apparatus. These modules or apparatus may include, but are not limited to, an application-specific integrated circuit (ASIC) chip, a field-programmable gate array (FPGA), a dedicated or shared processor that executes a particular software module or a piece of code at a particular time, and/or other programmable-logic devices now known or later developed. When the hardware modules or apparatus are activated, they perform the methods and processes included within them.

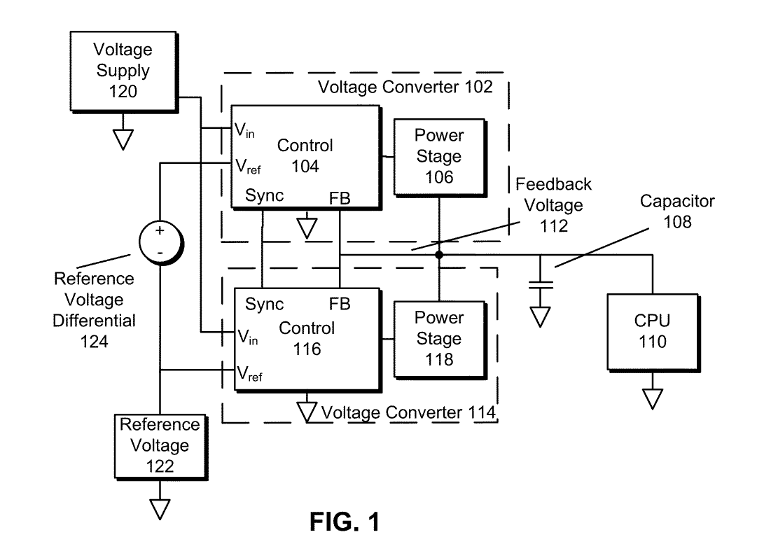

FIG. 1 shows a power supply in accordance with an embodiment. Voltage converter 102 includes control 104 coupled through power stage 106 and capacitor 108 to central processing unit (CPU) 110. Voltage converter 114 includes control 116 coupled through power stage 118 to power stage 106 and capacitor 108. Voltage supply 120 is coupled into control 104 and control 116, reference voltage 122 is coupled to control 116 and through reference voltage differential 124 to control 104, and feedback voltage 112 is coupled to control 104 and control 116. Note also that control 104 outputs a synchronization (sync) reference to control 116.

Voltage converter 102 can generally be any type of dc-dc converter with a power limit and may be implemented in any technology. In some embodiments, voltage converter 102 is a constant on-time buck regulator with a preset power limit. In some embodiments, voltage converter 102 may be replaced by any other type of power limited voltage converter that produces a regulated output voltage, including but not limited to a single-ended primary-inductor converter (SEPIC), a Cuk converter, or a class-E DC/DC converter.

Control 104 includes feedback control for voltage converter 102 that uses feedback voltage 112 and the reference voltage input (e.g., the output from reference voltage differential 124) to control power stage 106 to output a regulated voltage at or near the reference voltage input to control 104. The feedback control circuitry in control 104 may include an error amplifier that generates a negative feedback control signal based on the reference and feedback voltages input into control 104. Control 104 outputs a sync reference to control 116. In some embodiments, the output sync reference is related to the frequency used by control 104 to control power stage 106.

Power stage 106 can be any power stage for use with a voltage converter. For example, power stage 106 may include but is not limited to circuitry that includes one or more of the following elements: switching power transistors controlled by control 104, diodes, and an output inductor. Note that capacitor 108 can be any type of capacitor for use with a dc-dc converter such as voltage converter 102. In some embodiments, capacitor 108 may be replaced by one or more capacitors located in power stage 106 and/or one or more capacitors located in power stage 118.

Voltage converter 114 can generally be any type of voltage converter with a power limit higher than the power limit of voltage converter 102 and it may be implemented in any technology. In some embodiments, voltage converter 114 is a current-mode controlled buck regulator with a power limit above the power limit of voltage converter 102. Note that in some embodiments, the power limit of voltage converter 114 may be determined by design of control 116 while in other embodiments, the power limit of voltage converter 114 is the output power at which voltage converter 114 may become damaged or unable to output a regulated voltage. In some embodiments, the power limit of voltage converter 114 is at least 2 times the power limit of voltage converter 102. Additionally, in some embodiments, voltage converter 114 may be replaced by any other type voltage converter that produces a regulated output voltage and has a power limit higher than the power limit of voltage converter 102 (or any other type of voltage converter used in place of voltage converter 102), and may include but is not limited to a single-ended primary-inductor converter (SEPIC), a Cuk converter, or a class-E DC/DC converter.

Control 116 includes feedback control for voltage converter 114 that uses feedback voltage 112 and the reference voltage input (from reference voltage 122) to control power stage 118 to output a regulated voltage at or near the reference voltage input to control 116. The feedback control circuitry in control 116 may include an error amplifier that generates a negative feedback control signal based on the reference and feedback voltages input in to control 116.

Additionally, control 116 uses the sync reference from control 104 to maintain a fixed relationship in the phase between the switching signal for power stage 106 and the switching signal for power state 118. Note also that in some embodiments, control 116 uses the sync reference from control 104 to ensure that the frequency of power stage 118 for voltage converter 114 is an integer multiple of the switching signal in control 104 for power stage 106. In other embodiments, the sync reference can be replaced by any other synchronization signal (including a clock reference) that may be generated by control 104, or an external synchronization source (not shown) that is input into control 104 and control 116 to maintain a fixed phase relationship between the switching signals for power stage 106 and power stage 118.

Power stage 118 can be any power stage for use with a voltage converter. For example, power stage 118 may include but is not limited to circuitry that includes one or more of the following elements: switching power transistors controlled by control 116, diodes, and an output inductor. Note that if power stage 118 includes an output inductor, then in embodiments in which the efficiency of voltage converter 114 is less important (e.g., because power stage 118 is often at a 0% duty cycle and not delivering power to CPU 110), then the output inductor can have a shape and/or configuration that results a lower efficiency while meeting other design constraints (e.g., board space). For example, the output inductor may be composed of one or more inductor coils with a square, rectangular, oval, or other non-circular or non-uniform cross-section or it may be shaped based on the size of the space available for it to fit in.

CPU 110 can be any type of instruction processor for any type of electronic device, including but not limited to a smartphone, a tablet computer, a laptop computer, or a desktop computer. In some embodiments, other systems in addition to or instead of CPU 110 are powered by the power supply of FIG. 1, including but not limited to a graphics processing unit (GPU), or any other load whose current consumption varies over time.

Voltage supply 120 is any voltage supply that outputs a voltage that can be input into a voltage converter such as voltage converter 102 and voltage converter 114. Voltage supply 120 may include but is not limited to a DC power supply, a full bridge rectifier, or one or more batteries.

Reference voltage 122 is any voltage reference and is used by the feedback loop (not shown) in control 116 to control the output of voltage converter 114. Similarly reference voltage differential 124 is any reference voltage supply that that can supply a reference voltage differential. The output of reference voltage differential 124 is a reference voltage that is the sum of the output of reference voltage 122 and the voltage differential across reference voltage differential 124 and is used by the feedback loop (not shown) in control 104 to control the output of voltage converter 102. Note that in some embodiments, the reference voltage differential of reference voltage differential 124 is chosen to be larger than the sum of the voltage offset of the error amplifier in the feedback control circuit of control 104 and the offset voltage of the error amplifier in the feedback control circuit of control 116, and generally is two to ten time times larger than this sum of offset voltages. Furthermore in some embodiments, the reference voltage differential of reference voltage differential 124 is chosen to be two to ten times larger than the larger of: the sum of the voltage offset of the error amplifier in the feedback control circuit of control 104 and the offset voltage of the error amplifier in the feedback control circuit of control 116, and the equivalent series resistance of capacitor 108 multiplied by the peak current output of voltage converter 102.

The power supply of FIG. 1 operates as follows. When CPU 110 draws an amount of power that is below the power limit of voltage converter 102, control 104 controls voltage converter 102 to output a voltage to CPU 110 that is regulated by the feedback loop in control 104 to be at the level of the reference voltage input into control 104 (e.g., from reference voltage differential 124). Since this voltage is above the reference voltage input to control 116 for voltage converter 114, voltage converter 114 is controlled by control 116 to stop delivering power to CPU 110. For example, when the feedback voltage to control 116 is larger then the reference voltage input to control 116, control 116 will prevent voltage converter 114 from delivering power by operating power stage 118 at a 0% duty cycle. Thus, when CPU 110 draw power at a level below the power limit of voltage converter 102, the voltage input to CPU 110 comes from voltage converter 102 and is regulated to a voltage equal the reference input to control 104 (e.g., higher than the reference voltage input to control 116 by the voltage differential of reference voltage differential 124).

When CPU 110 increases the power load, eventually its power demands will exceed the power limit of voltage converter 102. When this happens, since voltage converter 102 is power limited, the output voltage of voltage converter 102 will begin to decrease as the power demands of CPU 110 continue to rise above the power limit of voltage converter 102. When the output voltage of voltage converter 102 decreases to the reference voltage input to control 116, control 116 will start controlling voltage converter 114 to output power to CPU 110 at the voltage level determined by control 116 using the reference voltage input from reference voltage 122. Note than while control 116 is controlling voltage converter 114 to deliver power to CPU 110 at the reference voltage output from reference voltage 122, control 104 is still independently trying to control voltage converter 102 to deliver power to CPU 110 at the reference voltage output from reference voltage differential 124. However, as discussed above, the power demanded by CPU 110 exceeds the power limit of voltage converter 102.

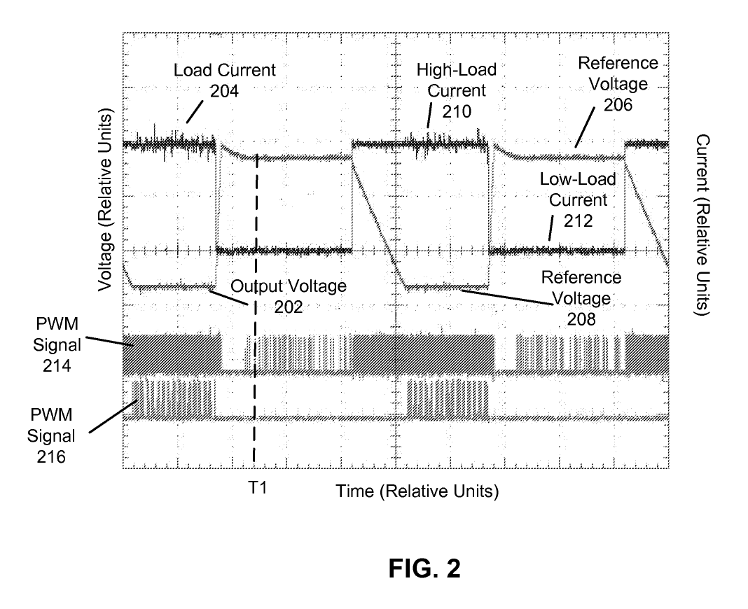

FIG. 2 depicts exemplary graphs of the output voltage, load current and PWM signals of voltage converters in accordance with an embodiment such as that depicted in FIG. 1. Output voltage 202 is a graph of voltage (in relative units) versus time (in relative units) for the power supply of FIG. 1 (e.g., at the input to CPU 110), and load current 204 is a graph of current (in relative units) versus time (in relative units) drawn by the load attached to the power supply (i.e., CPU 110). Load current 204 alternates between high-load current 210 and low-load current 212, which may represent the power demands of CPU 110 in two states of operation. Note that at high-load current 210 the CPU draws power at a level that exceeds the power limit of voltage converter 102.

Reference voltage 206 is the reference voltage input into control 104 (e.g., from reference voltage differential 124) while reference voltage 208 is the reference voltage input into control 116 (e.g., from reference voltage 122). Pulse width modulation (PWM) signal 214 is the PWM signal from control 104 of voltage converter 102 and PWM signal 216 is the PWM signal from control 116 of voltage converter 114. Note that the relationship between PWM signal 214 and PWM signal 216 represents the phase relationship of the switching signals for control 104 and control 116 and is maintained in a fixed relationship.

Starting at time T1, load current 204 is at low-load current 212 and therefore the power delivered to CPU 110 is less than the power limit of voltage converter 102. Therefore, control 104 controls the output voltage of voltage converter 102 to reference voltage 206. PWM signal 214 shows that the power stage in control 104 is switching while PWM signal 216 shows that control 116 is not switching (e.g., operating at a 0% duty cycle). This is because control 104 can control voltage converter 102 to output enough power to CPU 110 while maintaining its output voltage at reference voltage 206.

After load current 204 jumps to the level of high-load current 210, output voltage 202 starts to fall because in the high-load current state, CPU 110 draws power at a level that exceeds the power limit of voltage converter 102. Also note that when load current 204 jumps to the level of high-load current 210, PWM signal 214 shows power stage 106 switching much more often than when the load current was low load current 212 as it attempts to output more power. Eventually, output voltage 202 falls to the level of reference voltage 208. At this point, as can be seen from PWM signal 216, control 116 increases the duty cycle of the switching of power stage 118 to deliver enough power to regulate the output voltage at reference voltage 208.

Then, when load current 204 again switches to low-load current 212, PWM signal 216 again shows a 0% duty cycle, since this power level is below the power limit of voltage converter 102. Control 104 is again able to control voltage converter 102 to deliver the required power while regulating the voltage output of voltage converter 102 at referenced voltage 206.

Note that in some embodiments, when the load current in going to change, a signal (not shown) from CPU 110 to control 104 and/or control 116 may be used alert control 104 and/or control 116 that the load current will be going up or down within a predetermined time period. For example, in the case that CPU 110 is going to increase its power demands, CPU 110 may send a signal to control 116 that it should start to increase the duty cycle of the switching of power stage 118 above 0%.

Note also that in some embodiments, a signal (not shown) from CPU 110 to control 116 and voltage differential 124 may be used to force control 116 to a 0% duty cycle and reduce reference voltage differential 124 to 0 volts.

Additionally, in some embodiments, reference voltage 122 and/or reference voltage 124 may be increased or decrease in response to a signal (not shown) from CPU 110, or any other system or sensor (not shown). For example, CPU 110 may send a signal to reference voltage 122 to increase its voltage based on a measurement of the current flowing into CPU 110 made using a sensor in CPU 110 or external to CPU 110.

Furthermore, in some embodiments, an output inductor in power stage 118 may be selected to have an inductance value that enables the regulated output voltage of voltage converter 114 to track changes in the reference voltage from reference voltage 122 within a desired response time. For example, in embodiments in which voltage converter 114 infrequently supplies power to CPU 110, the output inductor in power stage 118 may be chosen to have a smaller inductance value than might otherwise be selected. This smaller inductance value may reduce the efficiency of voltage converter 114 while it is delivering power to CPU 110, but the smaller inductance value may also allow the output voltage of voltage converter 114 to more quickly track changes in the reference voltage from reference voltage 122, potentially improving processing performance of CPU 110.

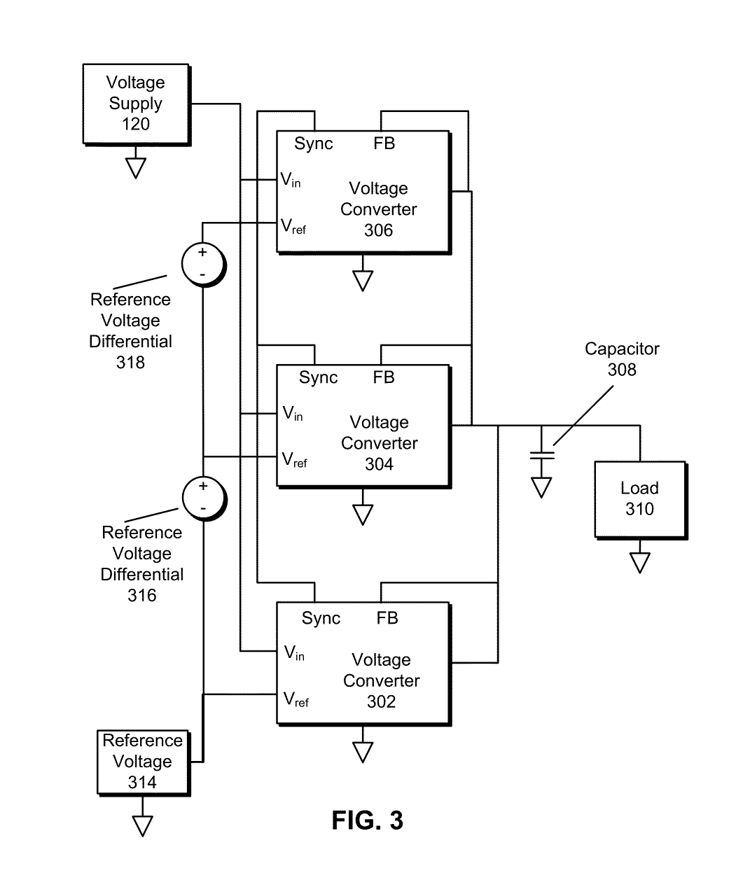

FIG. 3 shows a power supply including three voltage converters in accordance with an embodiment. Voltage converter 302, voltage converter 304, and voltage converter 306 are each coupled together at their outputs to capacitor 308 and load 310. Additionally, each of voltage converters 302, 304, and 306 has a feedback input (FB) coupled to capacitor 308 and a voltage input (Vin) coupled to voltage supply 120. Voltage converter 306 outputs a synchronization signal (sync) that is coupled to sync inputs on voltage converter 304 and voltage converter 302. Reference voltage 314 is coupled to voltage converter 302 and reference voltage differential 316, reference voltage differential 316 is additionally coupled to voltage converter 304 and reference voltage 318, and reference voltage differential 318 is further coupled to voltage converter 306.

Voltage converter 302 can be any type of voltage converter that produces a regulated output voltage with a power limit larger than that of voltage converter 304, and which is regulated by a feedback loop (not shown) in voltage converter 302 to output a regulated voltage at a level based on the reference voltage input (Vref) to voltage converter 302. Note that in some embodiments, voltage converter 302 has a fast transient response.

Additionally, voltage converter 304 can be any type of voltage converter that produces a regulated output voltage with a power limit larger than that of voltage converter 306, and which is regulated by a feedback loop (not shown) in voltage converter 304 to output a regulated voltage at a level based on the reference voltage input (Vref) to voltage converter 304.

Lastly voltage converter 306 can be any type of voltage converter that produces a regulated output voltage with a power limit less than that of voltage converter 304, and which is regulated by a feedback loop (not shown) in voltage converter 306 to output a regulated voltage at a level based on the reference voltage input (Vref) to voltage converter 306. In some embodiments, voltage converter 306 may be a low drop-out linear converter with no output inductor.

The sync output from voltage converter 306 to voltage converter 304 and voltage converter 302 is used to synchronize the phase of the voltage contributions to the coupled outputs of the voltage converters. For example, in some embodiments, the sync signal is used to fix the phase of a switching signal in voltage converter 302 and voltage converter 304 to that in voltage converter 306.

Reference voltage 314 is any voltage reference and is used a feedback loop (not shown) in voltage converter 302 to produce a regulated output voltage. Similarly reference voltage differential 316 is any reference voltage supply that that can supply a reference voltage differential. The output of reference voltage differential 316 is a reference voltage that is the sum of the output of reference voltage 314 and the voltage differential across reference voltage differential 316 and is used by a feedback loop (not shown) in voltage converter 304 to produce a regulated output voltage. Note that in some embodiments, the reference voltage differential of reference voltage differential 316 is chosen to be larger than the error in the feedback loops regulating the outputs of the voltage converter 302 and voltage converter 304. For example, the reference voltage difference of reference voltage differential 316 may be chosen to be larger than the sum of the voltage offset of an error amplifier in the feedback control circuit of voltage converter 302 and the offset voltage of an error amplifier in the feedback control circuit of voltage converter 304, and generally is two to ten time times larger than this sum of offset voltages.

Similarly reference voltage differential 318 is any reference voltage supply that that can supply a reference voltage differential. The output of reference voltage differential 318 is a reference voltage that is the sum of the output of reference voltage differential 316 and the voltage differential across reference voltage differential 318 and is used by a feedback loop (not shown) in voltage converter 306 to produce a regulated output voltage. Note that in some embodiments, the reference voltage differential of reference voltage differential 318 is chosen to be larger than the error in the feedback loops regulating the outputs of the voltage converter 304 and voltage converter 306. For example, the reference voltage difference of reference voltage differential 316 may be chose to be larger than the sum of the voltage offset of an error amplifier in the feedback control circuit of voltage converter 304 and the offset voltage of an error amplifier in the feedback control circuit of voltage converter 306, and generally is two to ten time times larger than this sum of offset voltages.

Capacitor 308 may be any type of capacitor suitable for use in a power supply such as the one depicted in FIG. 3. Note that while in the embodiment of FIG. 3, capacitor 308 is depicted as a single capacitor, in other embodiments, capacitor 308 may be replaced by two or more capacitors and they may be housed in one or more of voltage converters 302, 304 and/or 306. Additionally load 310 may be any current sink whose amplitude is a function of time, and may include but is not limited to a CPU and/or a GPU.

The power supply of FIG. 3 operates as follows. When load 310 draws an amount of power that is below the power limit of voltage converter 306, voltage converter 306 outputs a voltage to load 310 that is regulated to be at the level of the reference voltage input into voltage converter 306 (e.g., from reference voltage differential 318). Since this voltage is above the reference voltage input to voltage converter 304 and voltage converter 302, voltage converter 304 and voltage converter 302 are regulated to withhold power delivery to load 310. Thus, when load 310 draws power at a level below the power limit of voltage converter 306, the voltage input to load 310 comes from voltage converter 306 and is regulated to a voltage equal to the reference voltage input to voltage converter 306 (e.g., higher than the reference voltage input to either voltage converter 304 or voltage converter 302.

When load 310 increases the power it draws, eventually its power demands will exceed the power limit of voltage converter 306. When this happens, since voltage converter 306 is power limited, its output voltage will begin to decrease as the power demands of load 310 continue to rise above its power limit. When the output voltage of voltage converter 306 decreases to the reference voltage input voltage converter 304, voltage converter 304 will start to output power to load 310 at the voltage level based on reference voltage input from reference voltage differential 316. Note that while the feedback loop in voltage converter 304 is controlling voltage converter 304 to deliver power to load 310 at the reference voltage output from reference voltage differential 316, the feedback loop in voltage converter 306 is still independently working to control voltage converter 306 to deliver power to load 310 at the reference voltage output from reference voltage differential 318.

Then, when load 310 further increases the power it draws, eventually its power demands will exceed the power limit of voltage converter 304. When this happens, since voltage converter 304 is power limited, its output voltage will begin to decrease as the power demands of load 310 continue to rise above its power limit. When the output voltage of voltage converter 304 decreases to the reference voltage input to voltage converter 302, voltage converter 302 will start to output power to load 310 at the voltage level based on reference voltage input from reference voltage 314. Again, note than while the feedback loop in voltage converter 302 is controlling voltage converter 302 to deliver power to load 310 at the reference voltage output from reference voltage 314, the feedback loop in voltage converter 304 is still independently trying to control voltage converter 304 to deliver power to load 310 at the reference voltage output from reference voltage differential 316, and the feedback loop in voltage converter 306 is also still independently working to control voltage converter 306 to deliver power to load 310 at the reference voltage output from reference voltage differential 318.

Note that in other embodiments, more than three voltage converters may be use, with each voltage converter having a higher reference voltage and a lower power limit than the previous voltage converter.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A power supply, comprising:
a first voltage converter having a first regulated output;
a first feedback controller in the first voltage converter;
a second voltage converter having a second regulated output electrically coupled to the first regulated output, wherein a power limit of the first voltage converter is lower than a power limit of the second voltage converter; and
a second feedback controller in the second voltage converter, wherein a reference voltage for the first feedback controller is higher than a reference voltage for the second feedback controller.

2. The power supply of claim 1, wherein a phase relationship between a switching signal of the first voltage converter and a switching signal of the second voltage converter is held substantially constant.

3. The power supply of claim 1, wherein a switching frequency of the second voltage converter is an integer multiple of a switching frequency of the first voltage converter.

4. The power supply of claim 1, wherein the first voltage converter includes a first buck regulator and the second voltage converter includes a second buck regulator.

5. The power supply of claim 4, wherein:
the first buck regulator includes a first output inductor; and
the second buck regulator includes a second output inductor electrically coupled to the first output inductor.

6. The power supply of claim 5, wherein the second output inductor includes a coil with a non-circular cross-section.

7. The power supply of claim 1, wherein the first feedback controller includes a first error amplifier and the second feedback controller includes a second error amplifier.

8. The power supply of claim 7, wherein a difference between the first reference voltage and the second reference voltage is between two and ten times a sum of an offset voltage of the first error amplifier and an offset voltage of the second error amplifier.

9. The power supply of claim 1, wherein the second feedback controller is configured to receive a signal that varies a duty cycle of the second voltage converter between 0% and 100%.

10. The power supply of claim 1, wherein the second feedback controller is configured to receive a signal that decreases a duty cycle of the second voltage converter to 0% and sets the reference voltage for the first feedback controller equal to the reference voltage for the second feedback controller.

11. The power supply of claim 1, further comprising:
a third voltage converter having a third regulated output electrically coupled to the first regulated output and the second regulated output, wherein the power limit of the second voltage converter is lower than a power limit of the third voltage converter; and
a third feedback controller in the third voltage converter, wherein the reference voltage for the second feedback controller is higher than a reference voltage for the third feedback controller.

12. The power supply of claim 1, further comprising:
a current sink electrically coupled to the first regulated output and the second regulated output, wherein a current consumption of the current sink varies over time.

13. A power supply for an electronic device, comprising:
a first voltage converter having a first output;
a first feedback controller in the first voltage converter, wherein the first feedback controller includes a first negative feedback error amplifier to receive a first reference voltage and a feedback voltage from the first output;
a second voltage converter having a second output electrically coupled to the first output, wherein a power limit of the first voltage converter is lower than a power limit of the second voltage converter; and
a second feedback controller in the second voltage converter, wherein the second feedback controller includes a second negative feedback error amplifier to receive a second reference voltage and a feedback voltage from the second output, and wherein the first reference voltage is higher than the second reference voltage.

14. The power supply of claim 13, wherein a phase relationship between a switching signal of the first voltage converter and a switching signal of the second voltage converter is held substantially constant.

15. The power supply of claim 13, wherein the first voltage converter includes a first buck regulator and the second voltage converter includes a second buck regulator.

16. The power supply of claim 13, wherein the first output includes a first output inductor and the second output includes a second output inductor, and the second inductor includes a coil with a non-circular cross-section.

17. The power supply of claim 13, wherein a difference between the first reference voltage and the second reference voltage is between two and ten times a sum of an offset voltage of the first error amplifier and an offset voltage of the second error amplifier.

18. The power supply of claim 13, wherein the second feedback controller is configured to receive a signal that varies a duty cycle of the second voltage converter between 0% and 100%.

19. The power supply of claim 13, wherein the second feedback controller is configured to receive a signal that decreases a duty cycle of the second voltage converter to 0% and sets the first reference voltage equal to the second reference voltage.

20. The power supply of claim 13, further comprising:
a third voltage converter having a third output electrically coupled to the first output and the second output, wherein the power limit of the second voltage converter is lower than a power limit of the third voltage converter; and
a third feedback controller in the third voltage converter, wherein the third feedback controller includes a third negative feedback error amplifier to receive a third reference voltage and a feedback voltage from the third output, and wherein the second reference voltage is higher than the third reference voltage.

21. The power supply of claim 13, further comprising:
a current sink electrically coupled to the first output and the second output, wherein a current consumption of the current sink varies over time.

22. A method for controlling a power supply, comprising:
controlling a first buck regulator using a first feedback controller, wherein the first feedback controller controls the first buck regulator based on a first reference voltage; and
controlling a second buck regulator using a second feedback controller, wherein the second feedback controller controls the second buck regulator based on a second reference voltage, and the first reference voltage is higher than the second reference voltage, and wherein a first output inductor of the first buck regulator is electrically coupled to a second output inductor of the second buck regulator.

23. The method of claim 22, further including:
maintaining a substantially fixed phase relationship between a switching signal of the first buck regulator and a switching signal of the second buck regulator.

24. The method of claim 23, further including:
operating the second buck regulator at a switching frequency that is an integer multiple of a switching frequency of the first buck regulator.

25. The method of claim 22, wherein the second inductor includes a coil with a non-circular cross-section.

26. The method of claim 22, wherein a difference between the first reference voltage and the second reference voltage is between two and ten times a sum of an offset voltage of the first error amplifier and an offset voltage of the second error amplifier.

27. The method of claim 22, further comprising:
controlling a third buck regulator using a third feedback controller, wherein the third feedback controller controls the third buck regulator based on a third reference voltage, and the second reference voltage is higher than the third reference voltage, and wherein the second output inductor of the second buck regulator is electrically coupled to a third output inductor of the third buck regulator.

28. The method of claim 22, wherein controlling the second buck regulator includes controlling the second buck regulator to increase a duty cycle of the second buck regulator above 0% in response to a signal.

29. The method of claim 22, wherein controlling the second buck regulator includes controlling the second buck regulator to decrease a duty cycle of the second buck regulator to 0% and set the first reference voltage equal to the second reference voltage in response to a signal.
